(19) United States
(12) Patent Application Publication
(10) Pub. No.: US 2006/0122915 A1
(43) Pub. Date: Jun. 8, 2006

(54) Customizable home improvement and redecoration pictorial display assistant

(76) Inventor: Anita L. Allen, Roanoke, TX (US)

Correspondence Address: STEPHEN R. LOE, THE LAW OFFICE OF STEPHEN R. LOE, P.O. BOX 649, FRISCO, TX, 75034, US

(21) Appl. No.: 11/000,298

(22) Filed: Nov. 30, 2004

(51) Int. Cl. G06F 17/30

(52) U.S. Cl. 705/27

(57) ABSTRACT

A method, system, and computer program product for presenting a manipulatable customized image to a user for aiding in visualizing how home improvement ideas would appear in a user's decorating space using an image received from the user is provided. In one embodiment, the system acquires an image of a user's decorating space. Responsive to a request by the user, the system manipulates the image to add a home improvement, such as, for example, wall paint, wall paper, window treatments, etc., to the image of the user's decorating space and presents this manipulated image to the user, thereby allowing the user to visualize how a particular home improvement would appear when applied to the user's own room, landscaping, or building exterior rather than having to rely on how the home improvement looks on a stock photograph that might be dissimilar to the user's decorating space.

### BACKGROUND OF THE INVENTION

1. Technical Field

The present invention relates to computer software and, more particularly to customizing images to aid in selecting items for home improvement and home redecorating.

2. Description of Related Art

Home improvement is a multi-billion dollar industry as is evident by the numbers of home improvement stores, paint retailers, and furniture stores that exist in the United States alone. However, when doing home improvement, it is often hard to visualize how particular improvements would look with a particular home. This is especially true for individuals performing improvements on their own homes, but is even sometimes true for professional designers. For example, for most people, it is difficult to determine what paint would look best with your existing home decor or what finish would look best on the exterior of a home.

Currently, there are software programs available that allow one to choose various color palettes and view an exemplary room illustrating the color palettes, but the homes are not specific to the individual or their personal decor. Rather, these homes are generic and often chosen to present the product offered for sale in its most appealing form. Furthermore, what looks good in one environment may look out of place in another environment. For example, what looks glamorous in a traditional home may look out of place in a stucco home.

Thus, in order to allow consumers to make better decisions about products to purchase for home redecorating, it would be great to have a method, system, and computer program product that allowed consumers to view decorating alternatives using a photo of their own home rather than a generic photo. This would therefore allow consumers to get an electronic visual image of what their home would look like with new decor (e.g., paint, flooring, fixtures, furniture, etc.) without having to waste time and money on the wrong decision.

### SUMMARY OF THE INVENTION

The present invention provides a method, system, and computer program product for presenting a manipulatable customized image to a user for aiding in visualizing how home improvement ideas would appear in a user's decorating space using an image received from the user. In one embodiment, the system acquires an image of a user's decorating space. Responsive to a request by the user, the system manipulates the image to add a home improvement, such as, for example, wall paint, wall paper, window treatments, etc., to the image of the user's decorating space and presents this manipulated image to the user, thereby allowing the user to visualize how a particular home improvement would appear when applied to the user's own room, landscaping, or building exterior rather than having to rely on how the home improvement looks on a stock photograph that might be dissimilar to the user's decorating space.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented;

FIG. 4 depicts a block diagram of a personal digital assistant (PDA) in which the present invention may be implemented; and

FIG. 5 depicts a diagram illustrating an exemplary process flow and program function for a customized home improvement aid in accordance with one embodiment of the present invention.

### DETAILED DESCRIPTION OF THE PREFERRED EMBODIMENT

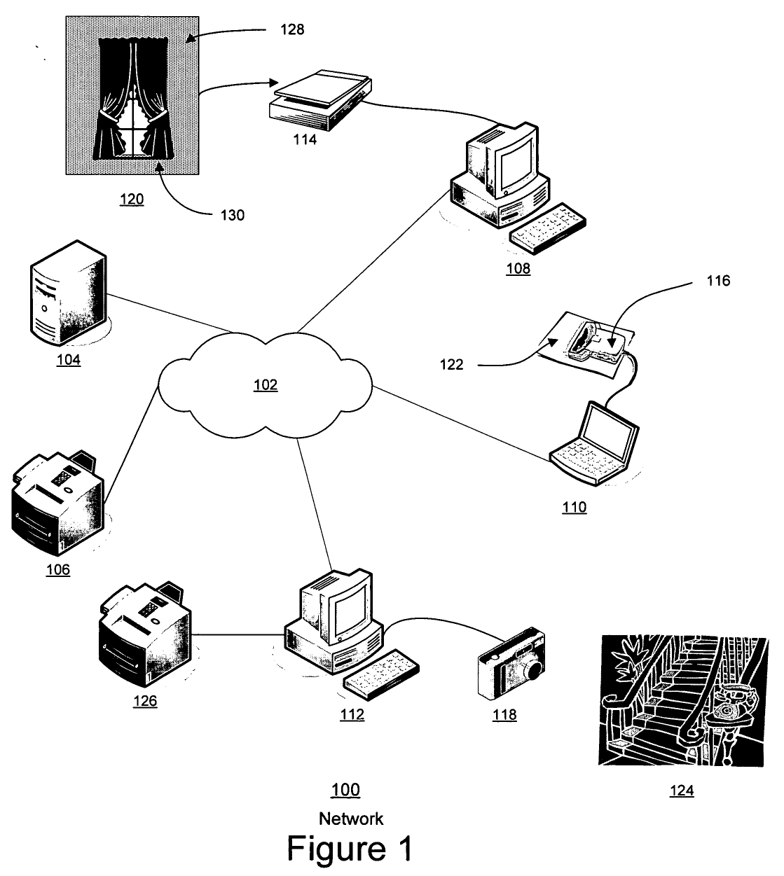

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with printer 106. In addition, clients 108, 110 and 112 are also connected to network 102. These clients, 108, 110 and 112, may be, for example, personal computers or laptop computers. A flatbed scanner 114 is connected to client 108 allowing digitized images of pictures, such as, for example, picture 120, to be loaded into data processing system 108 for manipulation by data processing system 108 or server 104. A handheld scanner 116 is connected to laptop computer 110 allowing digitized images of photographs or pictures 122 to be loaded into laptop 110. A digital camera 118 is connected to client 112. Camera 118 may take photographs of areas of a room or house, such as, for example, room section 124 and download these images into client 112. A printer 126 is also connected to client 112, thereby allowing the photographs to be printed.

In the depicted example, server 104 provides a web page to allow consumers to provide pictures of areas of their home that they desire to have remodeled. Server 104 may also provide software allowing the consumer, once the user's picture has been uploaded to server 104, to view the picture with various items changed to show how the room or area would look with differing decor. In one embodiment, the server 104 could allow the user to select certain areas of the picture, perhaps by using a mouse and cursor to draw lines around an area of the picture, and have this area of the picture changed using decor provided by the online retailer operating server 104. For example, the area selected by the user could correspond to the walls in a room. The user could then select a paint color offered by the retailer and have the wall color in the picture changed to match the selected paint color. Thus, the user could see how the room would look with various paint colors without the necessity of actually painting the room, thereby saving untold hours of time and money.

In one example, a user could take a picture 120 and scan the picture into a client 108 using a scanner 114. Once a digitized image of the picture 120 has been created, the picture 120 is uploaded to server 104 which then provides tools for manipulating the picture to see how various design changes appear in the room represented by picture 120. For example, as indicated above, the area 128 of the picture that represent the walls of the room could be selected by the user and then re-colored to match various paint color choices offered by a retailer. In addition, the curtains 130 could also be selected and the color changed to show how the room would appear with a different color curtain. Alternatively, the curtains 130 could be removed from picture 120 by the server 104 and the user could drag and drop curtains from a list of curtain styles and colors provided by the retailer. Thus, the user could see how the room would look with different types of curtains. Additionally, images of furniture could be dragged and dropped to various locations on picture 120 to allow the user to see how various furniture styles and combinations might work in the room represented by picture 120. However, these examples of manipulations that may be performed on picture 120 are merely presented as examples. As those skilled in the art will recognize, the picture 120 may be manipulated in a myriad of ways to demonstrate how the room would look with different decor.

In addition to viewing the image of the room or area, the user may print one or more images to either a directly connected printer, such as, for example, printer 126, or to a network printer, such as, for example, printer 106. In this way, the user may have a hard copy to look at rather than an image displayed on a computer screen. Such an option may be preferable for some users.

Distributed data processing system 100 may include additional servers, clients, and other devices not shown. Distributed data processing system 100 also includes printers 114, 116 and 118. A client, such as client 110, may print directly to printer 114. Clients such as client 108 and client 112 do not have directly attached printers. These clients may print to printer 116, which is attached to server 104, or to printer 118, which is a network printer that does not require connection to a computer for printing documents. Client 110, alternatively, may print to printer 116 or printer 118, depending on the printer type and the document requirements.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network.

FIG. 1 is intended as an example and not as an architectural limitation for the processes of the present invention.

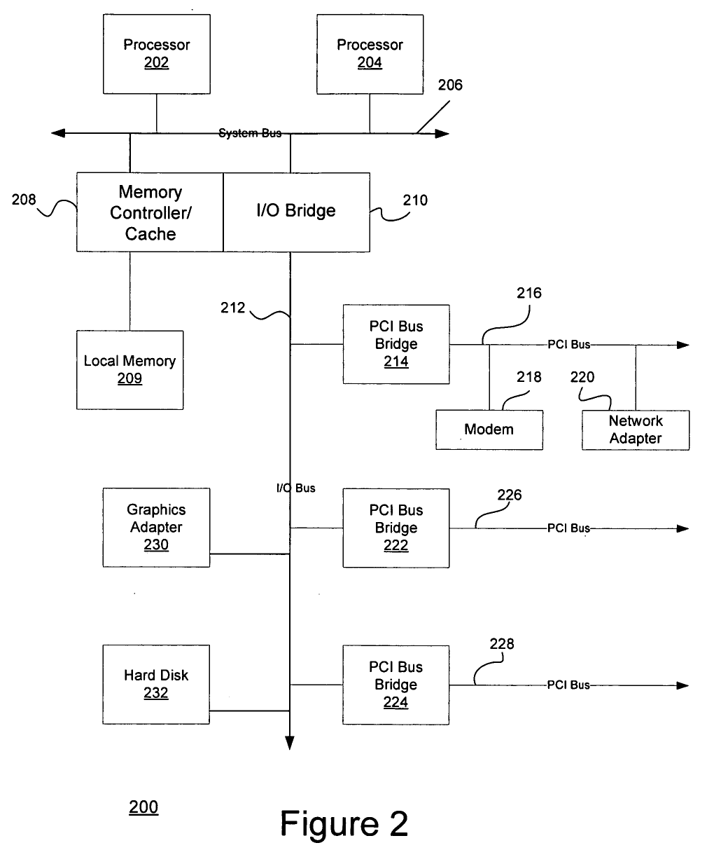

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

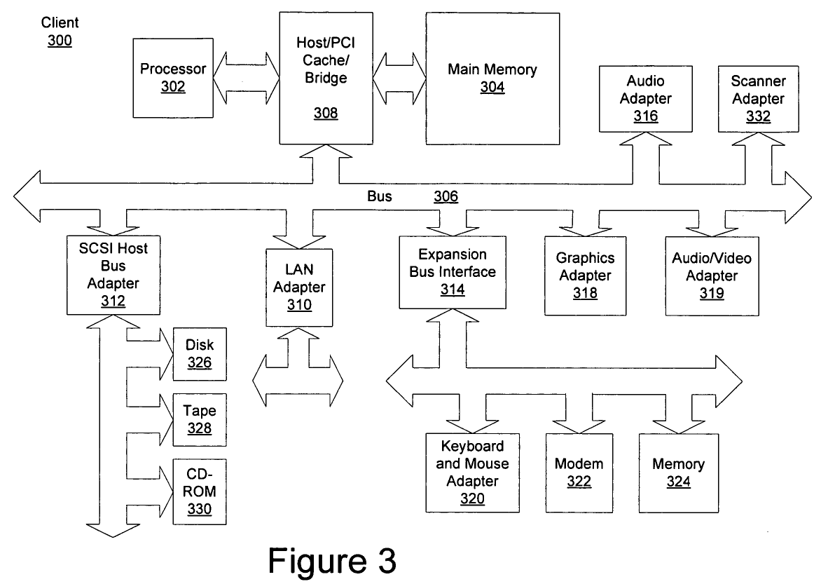

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and a scanner/digital camera adapter 332. Scanner/digital camera adapter 332 provides an interface by which a scanner, such as, for expel, scanner 114 depicted in FIG. 1, or a digital camera, such as, for example, camera 118 depicted in FIG. 1, may be connected to data processing system 300 in order to allow a user to upload images to data processing system 300. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

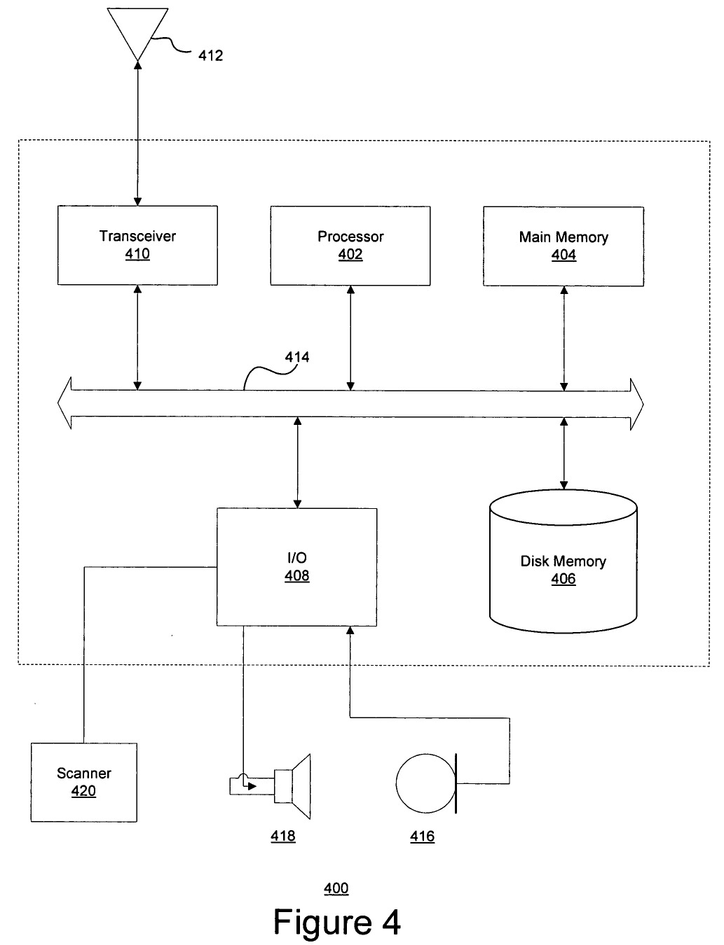

Turning now to FIG. 4, a block diagram of a personal digital assistant (PDA) is illustrated in which the present invention may be implemented. A PDA is a data processing system (i.e., a computer) which is small and portable. The PDA is typically a palmtop computer or smartphone, such as, for example, a Treo™ 600, a product and registered trademark of PalmOne, Inc. in Milpitas, Calif., which may be connected to a wireless communications network and which may provide voice, fax, e-mail, Internet access and/or other types of communication. The PDA 400 may perform other types of facilities to the user as well, such as, for example, provide a calendar and day planner. In addition to traditional functions of PDAs, PDA 400 is configured to capture photographs or other pictorial representations of, for example, a room within a building or the exterior of the building. PDA 400 is an example of a PDA or smartphone that may be implemented as, for example, PDA 110 depicted in FIG. 1.

PDA 400 may have one or more processors 402, such as a microprocessor, a main memory 404, a disk memory 406, and an I/O 408 such as a mouse, keyboard, or pen-type input, and a screen or monitor. The PDA 400 also has a wireless transceiver 410 connected to an antenna 412 configured to transmit and receive wireless communications to and from, for example, the Internet. The processor 402, memories 404, 406, I/O 408, and transceiver are connected to a bus 404. The bus transfers data, i.e., instructions and information, between each of the devices connected to it. The I/O 408 may permit faxes, e-mail, or optical images to be displayed on a monitor or printed out by a printer. The I/O 408 may be connected to a microphone 416 and a speaker 418 so that voice or sound information may be sent and received.

A scanner 420 is also be connected to the PDA 400 through I/O 408 allowing a user to scan pictures or photographs of the user's home, room, or other space to be decorated. The scanner 420 may be integrated into the physical design of the PDA 400 or maybe an external handheld device connected to the PDA via a cable or wirelessly.

Those of ordinary skill in the art will appreciate that the hardware in FIG. 4 may vary depending on the implementation. For example, PDA 400 may be enabled as a wireless telephone as well as a wirelessly enabled personal digital assistant. Furthermore, PDA 400 may have a camera function built into it, thereby obviating the need for an external scanner attachment. The depicted example is not meant to imply architectural limitations with respect to the present invention.

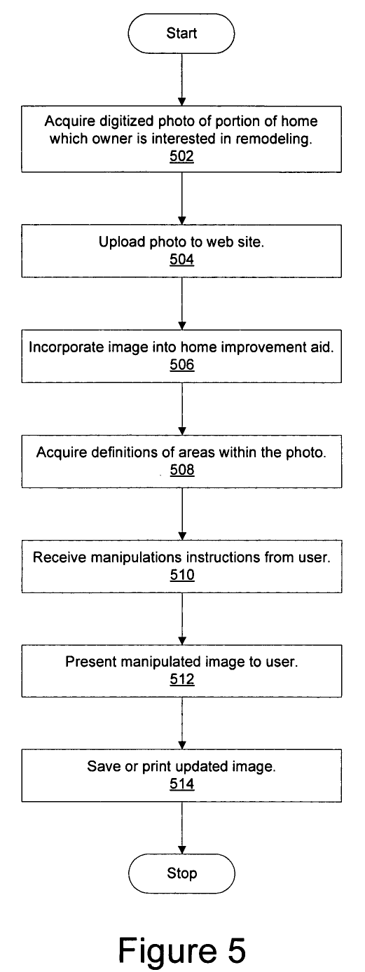

With reference now to FIG. 5, a diagram illustrating an exemplary process flow and program function for a customized home improvement aid is depicted in accordance with one embodiment of the present invention. To begin, a user acquires a digitized photo or scanned image of a portion of a home or other area that the user is interested in viewing various remodeling or redecorating options (step 502). Next, the user uploads the photo or image to a web site providing a home decorating aid (step 504). The web site incorporates the image into the home improvement or decorating aid (step 506) and presents the image to the user. The decorating aid then acquires definitions of areas within the photo or image (step 508). For example, the user may define which areas of the photo are walls, which are doors, and which are windows. The user may also define the dimensions (e.g., the height of the window, the length of the wall, etc.) of the various parts of the image.

Once the decorating aid has received the image and the dimensions, the image may be manipulated by the user to show how, for example, the room would look with various paint colors, wall paper, or window decorations. Thus, the decorating aid then receives manipulation instructions from the user (step 510) and presents the manipulated image to the user (step 512). The manipulation instructions may include, for example, selection from a palette of colors for wall colors, or selection of one of various options for window treatments that may be displayed over the window in the image. The user may then save or print the updated image (step 508). Alternatively, the user may select an item displayed in the manipulated image for purchase.

This present invention could easily be applied to custom home or commercial builders, especially when people are making one of the largest investment of their lives and are required to choose color palettes, flooring, cabinets and hardware in advance of the actual completion of the home or room. This is extremely taxing on individuals and/or couples as well as costly in terms of time and money.

Interior designers could also use the tool to electronically show customers what options they could consider. Right now, most designers complete pen/ink sketches of their plans and bring in fabric swatches.

Although the present invention has been described primarily with reference to interior home decorating, those skilled in the art will recognize that the present invention may be applied to exteriors of buildings and to landscaping as well. The present invention, thus, enables a user to visualize what their room, exterior, or landscaping would look like with various changes made to it.

It is important to note that although the present invention has been described primarily with reference to a web based system, the present invention may be applied in other network contexts or in stand alone systems. For example, rather than accessing the decorating aid via the Internet, a user may bring a photograph of their decorating space (e.g., room, exterior, or landscape area) to, for example, a store and have the image scanned into the store's decorating aid system. The user may then manipulate the image using the store's software. Alternatively, the user may bring a soft copy (e.g., a digitized copy of the image stored on a CD, DVD, or other computer readable media) of the image to the store and then load the image into the store's decorating aid software for manipulation.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for presenting a manipulatable image to a user for aiding in visualizing how home improvement ideas would appear in a user's decorating space, the method comprising:
acquiring an image of a user's decorating space;
responsive to a request by the user, manipulating the image to add a home improvement to the image of the user's decorating space.

2. The method as recited in claim 1, further comprising:
receiving, from the user, an indication of definitions of areas within the image that are associated with different aspects of the user's decorating space.

3. The method as recited in claim 2, wherein the different aspects of the user's decorating space comprise at least one of a wall, a window, a door, a floor, and a furniture piece.

4. The method as recited in claim 2, wherein the definitions of areas comprise dimensions of the various aspects of the user's decorating space.

5. The method as recited in claim 1, wherein the user's decorating space comprises one of at least a portion of a room, at least a portion of an exterior of a building, and a landscaping area.

6. The method as recited in claim 1, further comprising:
responsive to a request by the user, initiating a purchase process for an item displayed in the user's image.

7. The method as recited in claim 1, further comprising:
presenting a manipulated image to the user.

8. A computer program product in a computer readable media for use in a data processing system for presenting a manipulatable image to a user for aiding in visualizing how home improvement ideas would appear in a user's decorating space, the computer program product comprising:
first instructions for acquiring an image of a user's decorating space;
second instructions, responsive to a request by the user, for manipulating the image to add a home improvement to the image of the user's decorating space.

9. The computer program product as recited in claim 8, further comprising:
third instructions for receiving, from the user, an indication of definitions of areas within the image that are associated with different aspects of the user's decorating space.

10. The computer program product as recited in claim 9, wherein the different aspects of the user's decorating space comprise at least one of a wall, a window, a door, a floor, and a furniture piece.

11. The computer program product as recited in claim 9, wherein the definitions of areas comprise dimensions of the various aspects of the user's decorating space.

12. The computer program product as recited in claim 8, wherein the user's decorating space comprises one of at least a portion of a room, at least a portion of an exterior of a building, and a landscaping area.

13. The computer program product as recited in claim 8, further comprising:
third instructions for initiating, in response to a request by the user, a purchase process for an item displayed in the user's image.

14. The computer program product as recited in claim 8, further comprising:
third instructions for presenting a manipulated image to the user.

15. A system for presenting a manipulatable image to a user for aiding in visualizing how home improvement ideas would appear in a user's decorating space, the system comprising:
first means for acquiring an image of a user's decorating space;
second means, responsive to a request by the user, for manipulating the image to add a home improvement to the image of the user's decorating space.

16. The system as recited in claim 15, further comprising:
third means for receiving, from the user, an indication of definitions of areas within the image that are associated with different aspects of the user's decorating space.

17. The system as recited in claim 16, wherein the different aspects of the user's decorating space comprise at least one of a wall, a window, a door, a floor, and a furniture piece.

18. The system as recited in claim 16, wherein the definitions of areas comprise dimensions of the various aspects of the user's decorating space.

19. The system as recited in claim 15, wherein the user's decorating space comprises one of at least a portion of a room, at least a portion of an exterior of a building, and a landscaping area.

20. The system as recited in claim 15, further comprising:
third means for initiating, in response to a request by the user, a purchase process for an item displayed in the user's image.

21. The system as recited in claim 15, further comprising:
third means for presenting a manipulated image to the user.
